(19) United States
(12) Patent Application Publication
(10) Pub. No.: US 2018/0039160 A1
(43) Pub. Date: Feb. 8, 2018

(54) MAKING METHOD OF RANDOM UNEVEN DATA, OPTICAL ELEMENT, AND OPTICAL APPARATUS

(71) Applicant: CANON KABUSHIKI KAISHA, Tokyo (JP)

(72) Inventors: Kei Ueda, Atsugi-shi (JP); Kazuhiko Momoki, Koshigaya-shi (JP)

(21) Appl. No.: 15/665,768

(22) Filed: Aug. 1, 2017

(30) Foreign Application Priority Data
Aug. 3, 2016 (JP) 2016-152533

(51) Int. Cl. G03B 13/24; G06F 7/58

(52) U.S. Cl. CPC G03B 13/24; G06F 7/588

(57) ABSTRACT

A making method of random uneven data includes a step of making random uneven data by performing a filter operation in a real space using a filtering function with respect to random array data obtained using a random number or random array data obtained by randomly arranging a predetermined shape part.

### BACKGROUND OF THE INVENTION

### Field of the Invention

The present invention relates to a making method of random uneven data, an optical element, and an optical apparatus.

### Description of the Related Art

In light diffusion by a regularly array shape, diffusion characteristics are easily controlled using a pitch of an uneven surface, but a steep intensity peak is generated at a specific angle corresponding to each order. Thereby, a two-wire blur occurs. Moreover, in the diffusion by the regularly array shape, color unevenness occurs due to wavelength dependency of a diffraction angle. To improve the above harmful effects, applying a random uneven shape to a light diffusing element has been recently considered.

In light diffusion by a random uneven shape, a steep intensity peak is moderated, but controlling diffusion characteristics is difficult. Japanese Patent No. 4845290 discloses a making method of random uneven data introducing irregularity by a specific position shifting parameter with respect to a regularly array shape. Additionally, Japanese Patent Laid-Open No. 2014-119552 discloses a method to make random uneven data by performing a filter operation in a frequency space with respect to random data.

However, as the making method of Japanese Patent No. 4845290 introduces the irregularity with respect to the regularly array shape, deviation is generated in a shape position. When the deviation is generated in the shape position, undesirable unnatural light falloff occurs. Furthermore, when a random parameter increases, desired diffusion angle distribution cannot be obtained.

In addition, in the method for making the random uneven data of Japanese Patent Laid-Open No. 2014-119552, the filter operation in the frequency space cannot be performed to a divided necessary area, and thus need to be performed to the necessary area in a lump. Accordingly, for example, when random uneven data is formed on the whole area of a full size (36 mm×24 mm) image sensor, a large capacity memory is needed. Besides, as performing the batch operation to the whole area, the method for making the random uneven data of Japanese Patent Laid-Open No. 2014-119552 cannot make the random uneven data by non-linear filter processing, which varies characteristics continuously for each region.

### SUMMARY OF THE INVENTION

In view of the foregoing, the present invention provides a making method of random uneven data capable of making random uneven data having a desired frequency component and randomness without deviation in a two-dimensional space.

A making method of random even data as one aspect of the present invention includes a step of making random uneven data by performing a filter operation in a real space using a filtering function with respect to random array data obtained using a random number or random array data obtained by randomly arranging a predetermined shape part.

Further features of the present invention will become apparent from the following description of exemplary embodiments with reference to the attached drawings.

### BRIEF DESCRIPTION OF THE DRAWINGS

FIGS. 1A to 1F are explanatory views of a making method of random uneven data according to a first example.

FIG. 2 illustrates a frequency spectrum of the random uneven data according to the first example.

FIGS. 3A and 3B are explanatory views of an autocorrelation function of the random uneven data according to the first example.

FIG. 4 is a sectional view of a center of a filtering function according to the first example.

FIGS. 5A and 5B are explanatory views of a filter operation in a real space with respect to divided random array data according to the first example.

FIGS. 6A and 6B are explanatory views of a filter operation in a frequency space with respect to divided random array data.

FIGS. 7A to 7E are explanatory views of a making method of random uneven data according to a second example.

FIGS. 8A and 8B are explanatory views of an autocorrelation function of the random uneven data according to the second example.

FIGS. 9A to 9G are explanatory views of a filtering function according to a third example.

FIGS. 10A to 10J are explanatory views of a filtering operation according to the third example.

FIGS. 11A and 11B are explanatory views of an autocorrelation function of random uneven data according to the third example.

FIG. 12 illustrates a shape of a light diffusion element according to fourth to sixth examples.

FIGS. 13A and 13B are explanatory views of a random uneven shape according to the fourth example.

FIGS. 14A and 14B are explanatory views of a random uneven shape according to the fifth example.

FIG. 15 is a schematic diagram of an optical apparatus according to a seventh example.

FIG. 16 is a schematic diagram of an optical apparatus according to an eighth example.

FIGS. 17A and 17B are explanatory views of a making method according to a first comparative example.

FIGS. 18A and 18B are comparative diagrams of random uneven data.

FIGS. 19A to 19D are explanatory views of a light diffusion element according to a second comparative example.

### DESCRIPTION OF THE PREFERRED EMBODIMENTS

Exemplary embodiments of the present invention will be described below with reference to the accompanied drawings. In each of the drawings, the same elements will be denoted by the same reference numerals and the duplicate descriptions thereof will be omitted.

In this embodiment, random array data is obtained by using a random number or by randomly arranging a predetermined shape part. Performing a filter operation in a real space using a filtering function with respect to the obtained random array data, which is digital data, makes random uneven data. The random uneven data made in this way has a desired frequency component and randomness without deviation in a two-dimensional space. A random uneven shape that is formed on the basis of the random uneven data made by a method explained in this embodiment is used for an optical element such as a light diffusion element.

### FIRST EXAMPLE

In this example, a description will be given of a method for making random uneven data, which is one example of the present invention, by performing a filter operation in a real space using a filtering function having bandpass performance with respect to random array data obtained using a random number. Table 1 shows one example of set values of parameters and values of conditional expressions regarding this example.

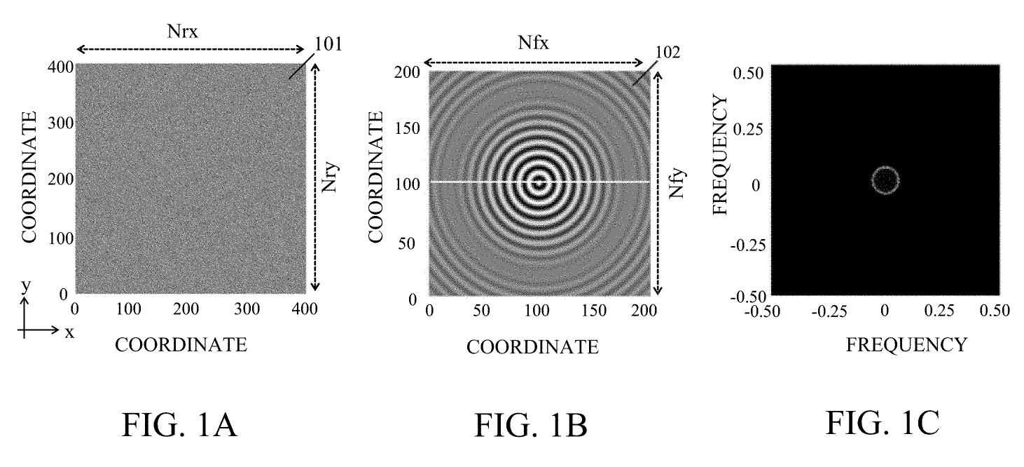

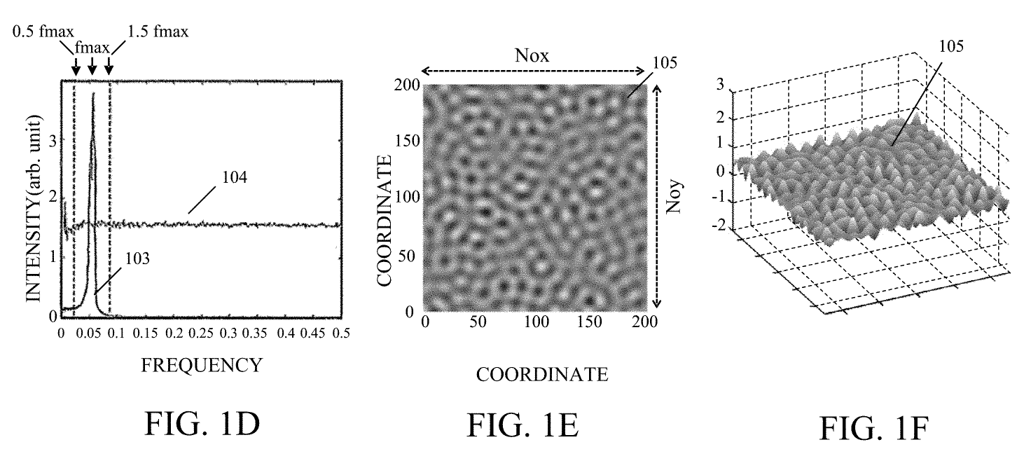

FIGS. 1A to 1F are explanatory views of a making method of random uneven data according to this example. FIG. 1A illustrates a two-dimensional random array data 101, which is digital data, given by a random number, and FIG. 1B illustrates a shape of a filtering function 102 used in the filter operation. All of digital data are given by two-dimensional grid data orthogonal to each other. In this example, Nrx and Nry are respectively an array length in each direction of two directions (x direction and y direction), which are orthogonal to each other, of the random array data 101, and Nfx and Nfy are respectively an array length in each direction of two directions (x direction and y direction), which are orthogonal to each other, of the filtering function 102. In this example, the array lengths Nrx and Nry are 399, and the array lengths Nfx and Nfy are 200. In this example, the array length is set to be relatively small, the present invention is not limited to this. Moreover, the array length may be set to be different in the x direction and the y direction.

In this example, a description will be given of the filter operation using data a(x,y) of an array length Na×Na, and data b(x, y) of an array length Nb×Nb having a size smaller than that of the data a(x,y). An output of the filter operation is data of (Na−Nb+1)×(Na−Nb+1) which is cut from a central part of data c(x,y) obtained by a convolution between grid data represented by the following expression (1). x and y are respectively coordinates in the x direction and the y direction, and are not continuous values but discrete values.

c(x,y)=a(x,y)*b(x,y) (1)

In this example, the filtering function 102 is expressed as a function g(r) of the following expression (4), which corresponds differences between values obtained by multiplying two sine functions fH(r) and fL(r) of the following expressions (2) and (3) by a constant number. r is a distance from a central position, that is, (x2+y2)^{0.5}, and α and β are constants. In this example, coefficients PH and PL are respectively 8.5 and 9.5.

fH(r)=[sin(Πr/PH)]/(Πr/PH) (2)

fL(r)=[sin(Πr/PL)]/(Πr/PL) (3)

g(r)=fH(r)/α−fL(r)/β (4)

α=∫|fH(r)|dr (5)

β=∫|fL(r)|dr (6)

FIG. 1C illustrates a two-dimensional frequency spectrum of the filtering function 102. As Fourier transformation is performed in the case where the grid size of the data is 1, the maximum frequency in the x direction and y-direction are 0.5. That is, the filtering function 102 has the bandpass performance. In this example, the filtering function 102 is a function having the bandpass performance, but may be a function having the lowpass performance.

FIG. 1D illustrates a frequency spectrum 103 obtained by making the two-dimensional frequency spectrum of the filtering function 102 into one-dimension in a radial direction, and a frequency spectrum 104 obtained by making the random array data 101 into one-dimension in a radial direction. As the random array data 101 is a random array, the frequency spectrum 104 has all frequency components approximately uniformly. An average frequency can be calculated from the one-dimensional frequency spectrum. In this embodiment, when fmax is a frequency having a maximum value in the one-dimensional frequency spectrum, a weighted average <f> is calculated using a weight average from 0.5 fmax to 1.5 fmax. In this example, the weighted average frequency <f> of the filtering function 102 is calculated to be 0.06 from the frequency spectrum 103.

FIG. 1E is an overhead view a two-dimensional random uneven data 105 made by performing the filter operation, and FIG. 1F is a perspective view of the random uneven data 105. Nox and Noy are respectively an array length in each direction of two directions (the x direction and the y direction), which is orthogonal to each other, of the random uneven data 105. The array lengths Nox and Noy are respectively equal to Nrx−Nfx+1 and Nry−Nfy+1.

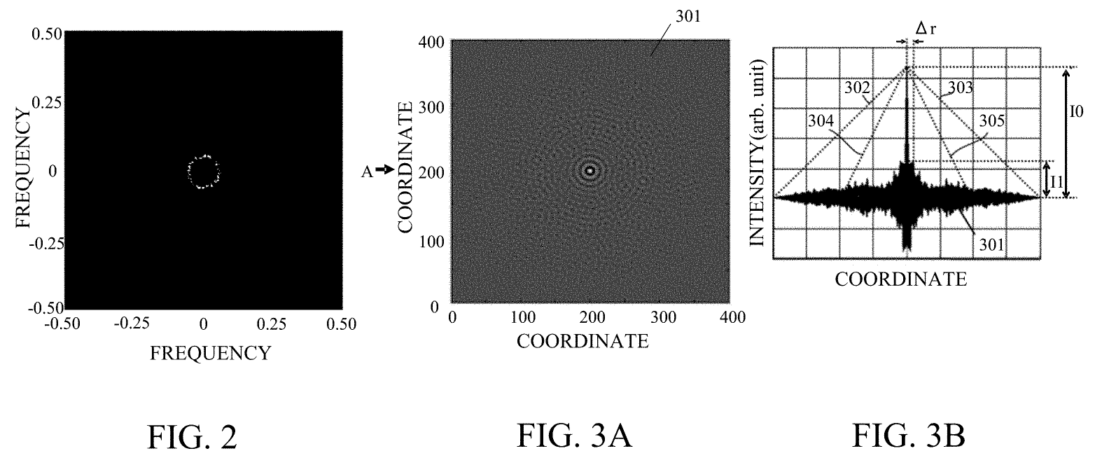

FIG. 2 illustrates a two-dimensional frequency spectrum of the random uneven data 105. As illustrated in FIG. 2, a two-dimensional frequency spectrum of the random uneven data 105 has frequency components nearly equal to those of the two-dimensional frequency spectrum of the filtering function 102 of FIG. 1C. That is, the frequency components of the random uneven data 105 is controlled by the filtering function 102. Additionally, as the random uneven data 105 does not have frequency components other than the frequency components of the filtering function 102, and thus has a two-dimensional shape without deviation.

FIGS. 3A and 3B are explanatory views of a two-dimensional autocorrelation function 301 of the random uneven data 105. FIG. 3A is an overhead view of the autocorrelation function 301, and FIG. 3B illustrates the autocorrelation function 301 when projected from the direction shown as an arrow A of FIG. 3A. When the autocorrelation function does not have a large intensity peak at a position other than an origin, the data generally has a shape with high randomness. Dotted lines 302 and 303 of FIG. 3B are envelopes of the peak generated in an autocorrelation function having a perfect regularly shape. The autocorrelation function 301 is far below the dotted lines 302 and 303 at positions other than the origin. That is, the random uneven data 105 has extremely high randomness.

As mentioned above, the random uneven data 105 has the desired frequency components, and has the randomness without deviation in the two-dimension.

In this example, to perform the filter operation in the real space, the array length of the filtering function 102 can be set to be shorter than that of the random array data 101. When the filter operation in the real space is performed, the filtering function 102 may be cut in a proper length, that is, the array length can be set to be short. Accordingly, operation memory necessary for the operation can be decreased.

Meanwhile, a filter operation in a frequency space is performed using the following expression (7).

C(kx,ky)=F[a(x,y)]·F[b(x,y)] (7)

Herein, F[a(x,y)] and F[b(x,y)] are respectively Fourier transformation of the data a(x,y) and the data b(x,y). kx and ky are respectively a discrete value representing a coordinate on the frequency space. As the expression (7) includes multiplication of matrix elements, the array length of the filtering function cannot be shortened.

In a filter operation in real space, too short array length increases deviations from desired frequency characteristics. Meanwhile, too large array length uses operation memory unnecessarily. Thus, the expression represented by the array lengths Nfx and Nfy of the filtering function 102 and the weighted average frequency <f> preferably satisfies the following conditional expression (8) to determine whether or not the array length is set appropriately.

4.0<(Nfx/Nfy)^{0.5}·<f><100.0 (8)

When the midst member of the expression (8) is smaller than the lower limit, the array length is too short, and thus filtering cannot be performed to have the desired frequency. When the midst member is larger than the upper limit, the array length is too long, and thus large operation memory is required. In this example, the midst member (Nfx/Nfy)^{0.5}·<f> is 11.2 and satisfies the expression (8). More preferably, the lower and upper limits are set to be 6.5 and 20, respectively.

Furthermore, the filtering function 102 need to have the lowpass performance or the bandpass performance to make the random uneven data 105 having the desired frequency components. When Cmax is a maximum value of absolute values of the filtering function 102 and rmin is the shortest distance from a coordinate corresponding to the maximum value Cmax to a coordinate corresponding to the absolute value Cmax/2, the shortest distance rmin preferably satisfies the following conditional expression (9).

0.4<rmin<1000.0 (9)

The performance of the filtering function 102 is evaluated using the expression (9). When the shortest distance rmin is smaller than the lower limit, the filtering function 102 has the highpass performance and thus is undesirable to be used for making the random uneven data 105. When the shortest distance rmin is larger than the upper limit, the grid size of the data is not appropriate, and memory and an operation time are required unnecessarily. More preferably, the upper limit of the expression (9) is set to be 40.

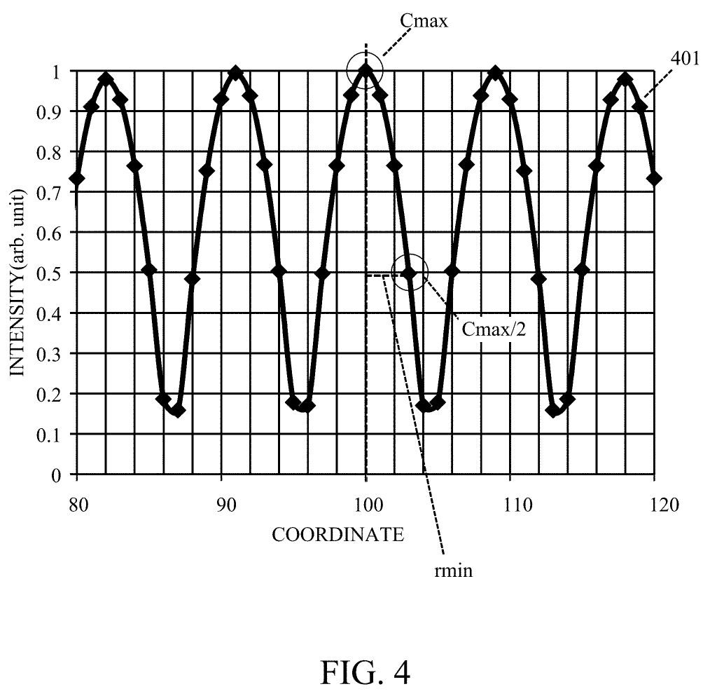

FIG. 4 illustrates is a sectional shape 401 of a dotted line in FIG. 1B of the filtering function 102. The sectional shape 401 includes the maximum value Cmax of the absolute values of the filtering function 102. As the filtering function 102 has a rotationally symmetrical shape, the shortest distance rmin is constant. As the filtering function 102 according to this example has the bandpass performance, the shortest distance rmin is 3.0 and satisfies the expression (9).

In addition, the randomness of the random uneven data 105 can be evaluated using the autocorrelation function 301. When I0 and I1 are respectively intensity of a maximum peak and intensity of a second peak in the autocorrelation function of the random uneven data 105 and Δr is a distance from the origin to a coordinate corresponding to the second peak, a peak intensity ratio I0/I1 preferably satisfies the following conditional expression (10).

0.05<11/10<1−2.5·Δr/(Nox·Noy)^{0.5} (10)

The randomness of the random uneven data 105 is evaluated using the expression (10). Having the peak intensity close to the dotted lines 302 and 303 in FIG. 3B, the random uneven data 105 has the shape close to the perfect regularly shape. The dotted lines 304 and 305 have a function shape represented by the following expression (11).

d(r)=1−2.5·r/(Nox·Noy)^{0.5} (11)

Herein, r is a distance from the center. When the distance Δr from the origin to the coordinate corresponding to the second peak is substituted for the distance r, the expression (11) corresponds to the right member of the expression (10). When the peak intensity I1 corresponding to the distance Δr is smaller than the dotted lines 304 and 305, the random uneven data 105 has the shape with high randomness.

Accordingly, when the peak intensity ratio I1/I0 is larger than the upper limit in the expression (10), the randomness of the random uneven data 105 is insufficiency. Using the random uneven shape formed on the basis of the random uneven data 105 for a surface shape of a light diffusion element causes influence of diffraction due to a regularly pitch, and thus is undesirable. Besides, when the peak intensity ratio I1/I0 is smaller than the lower limit, the randomness of the random uneven data 105 becomes too high. Using the random uneven shape formed on the basis of the random uneven data 105 for the surface shape of the light diffusion element cannot obtain the desired diffusion characteristics, and thus is undesirable. In this example, according to FIG. 3B, the distance Δr and the peak intensity ratio I1/I0 are calculated to be 6.0 and 0.27, respectively. Then, the right member of the expression (10) is 0.93, and thus the random uneven data 105 satisfies the expression (10).

Moreover, after dividing the random array data into a plurality of predetermined unit areas (unit random array data), the filter operation in the real space may be performed for each unit random array data. Performing the filter operation in the real space for each unit random array data can release operation memory after operating the unit random array data. Accordingly, large area random uneven data, which cannot be made by a batch operation due to limitation of capacity of operation memory, can be made.

When the filter operation is performed by dividing the random array data, the unit random array data preferably has a part (common area) overlapping with the adjacent unit random array data by the distance Nfx/2 in the x direction and the distance Nfy in the y direction. When the array lengths Nfx and Nfy are odd numbers, a length in the x direction and a length in the y direction of the overlapped part are preferably (Nfx−1)/2 and (Nfy−1)/2, respectively. Providing the overlapped part can connect the plurality of pieces of the unit random array data continuously. In this example, the length in the x direction and the length in the y direction of the overlapped part are respectively Nfx/2 and Nfy/2, but the present invention is not limited to this.

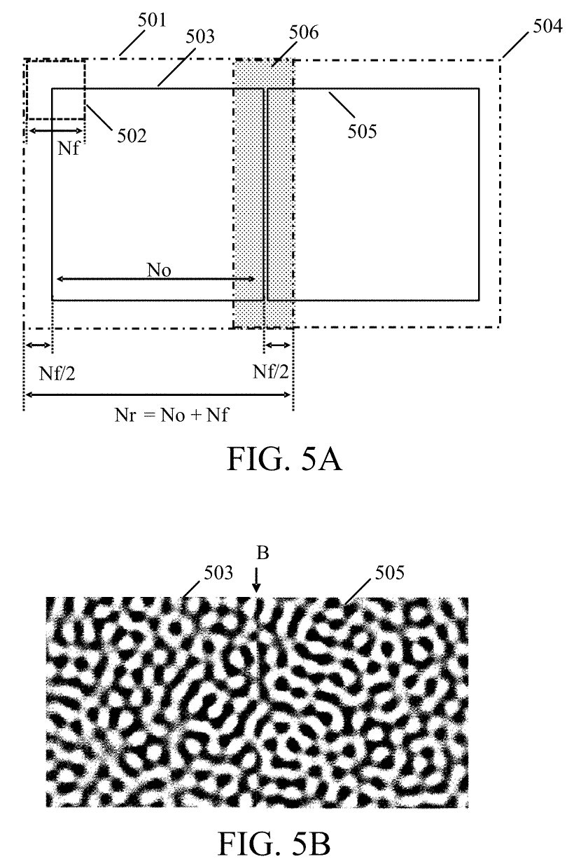

Referring to FIGS. 5A and 5B, a description will be given of performing the filter operation in the real space after dividing the random array data into the plurality of pieces of the unit random array data. FIGS. 5A and 5B are explanatory views of the filter operation in the real space with respect to the divided random array data. For simplification, in the description, the random array data is isotropic in the x direction and the y direction.

First, performing the filter operation in the real space using a filtering function 502 having array lengths of Nf×Nf with respect to unit random array data 501 having array lengths of Nr×Nr can obtain unit random uneven data 503 having array lengths of No×No. The array length No of the unit random uneven data 503 is Nr−Nf+1. After performing the filter operation, operation memory is released before performing next filter operation.

Next, performing the filter operation with respect to unit random array data 504 adjacent to the unit random array data 501 can obtain unit random uneven data 505. As illustrated in FIG. 5A, the unit random array data 504 includes an overlapped part 506 having a length of Nf/2 at the part adjacent to the unit random array data 501. The unit random array data 504 has the overlapped part 506, and thus, as illustrated in FIG. 5B, the unit random uneven data 503 and 505 are continuously connected on the light and left of a boundary position shown as an arrow B.

As mentioned above, performing the filter operation in the real space with respect to each unit random array data, which is divided from the random array data and has the overlapped part, can make unrepeated and large area random uneven data without limitation of operation memory.

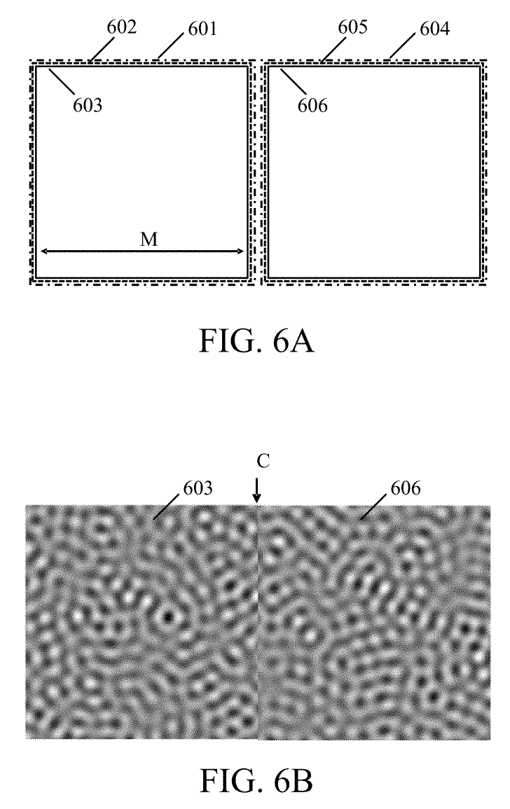

Referring to FIGS. 6A and 6B, a description will be given of performing the filter operation in the frequency space with respect to random array data divided into a plurality of unit areas. FIGS. 6A and 6B are explanatory views of the filter operation in the frequency space to divided random array data. As illustrated in FIG. 6A, performing the filter operation in the frequency space using a filtering function 602 having array lengths of M×M with respect to unit random array data 601 having unit array lengths of M×M can obtain random uneven data 603. Additionally, performing the filter operation in the frequency space using a filtering function 605 with respect to unit random array data 604 adjacent to the unit random array data 601 can obtain unit random uneven data 606. As represented by the expression (7), in the filter operation in the frequency space, there is no part to overlap adjacent random array data for connecting them. Thus, as illustrated in FIG. 6B, the random uneven data 603 and 606 are discontinuously connected on the light and left of a boundary position shown as an arrow C. That is, the filter operation in the frequency space cannot connect the unit random uneven data. Thus, a data size in making unrepeated and continuous random uneven data is limited to capacity of operation memory. If grid data of 240000×360000 is held at an 8-bit gradation, operation memory of 80 GB is required. Including the filtering function and the output random uneven shape, operation memory of about 240 GB is required. As a general calculator cannot have such huge capacity of operation memory, the above operation cannot be executed except for under a special calculation environment.

Herein, the case where the array lengths Nrx and Nry of the random array data are respectively 240000 and 360000 will be explained. As mentioned above, performing the filter operation in the real space with respect to each of the plurality of the unit areas divided from the random array data can make unrepeated and large area random uneven data without limitation of capacity of operation memory. The randomness of the random uneven data is higher than that of the random unevenness data 105 obtained on the basis of the random array data 101 having array lengths of 200×200. When the grid data of the random uneven data has the shape by 100 nm, large area random uneven shape of 24 mm×36 mm can be made on the basis of the random uneven data. That is, unrepeated random uneven shape can be formed on the whole area of a full-size image sensor. Using large area and unrepeated random uneven shape for the surface shape of the light diffusion element can suppress diffraction components due to the repetitive pitches.

Furthermore, the random uneven shape is formed on the surface of the optical element on the basis of the random uneven data using the method according to this example, an average pitch <Ps> calculated from the frequency characteristics of the random uneven shape preferably satisfies the following conditional expression (12).

0.8(μm)<<Ps><100(μm) (12)

The average pitch <Ps> is calculated from the weighted average of the frequency characteristics of uneven shape data obtained from the grid less than or equal to 200 nm detected by a measuring method such as Atomic Force Microscope (AFM) and Scanning Electron Microscope (SEM). When the average pitch <Ps> is larger than the upper limit, the shape is too large to use for the optical element and unnecessarily reflection easily occurs. When the average pitch is smaller than the lower limit, the shape has a size nearly equal to a wavelength in visible wavelength band and obtaining the effect of diffusion is difficult. More preferably, the upper limit and the lower limit of the expression (12) are respectively 40 μm and 1.5 μm.

In addition, when the random uneven shape is formed on the surface of the optical element on the basis of the random uneven data made by the method according to this example, a ratio of the average value (average height) <hs> of heights of the random uneven shape to the average pitch <Ps> desirably satisfies the conditional expression (13).

0.01<<hs>/<Ps><2.0 (13)

The average value <hs> of heights is calculated from the weighted average of heights of uneven shape data obtained from the grid less than or equal to 200 nm detected by the measuring method such as AFM and SEM. When the aspect ratio of <hs>/<Ps> is larger than the upper limit, the aspect ratio is too large and total reflection strongly occurs in using as the light diffusion element in addition to difficulty of making. When the aspect ratio <hs>/<Ps> is smaller the lower limit, the shape is too small with respect to a wavelength in visible wavelength band and obtaining the effect of diffusion is difficult.

Besides, the random uneven shape on the basis of the random uneven data made by the method according to this example is preferably formed using a gray scale lithography technology and a nanoimprint technology. An organic material may be used, but using an inorganic material is preferable in the light of warpage and durability. Moreover, the forming method is one example, and does not limit an effect of the present invention. The random uneven shape may be formed using an appropriate method as usage.

### SECOND EXAMPLE

Random array data according to this example are obtained by arranging circles on the basis of a predetermined array regulation. In this example, a description will be given of a method to make random uneven data by performing a filter operation in a real space using a filtering function having bandpass performance with respect to the obtained random array data. Table 2 shows one example of set values of parameters and values of conditional expressions regarding this example.

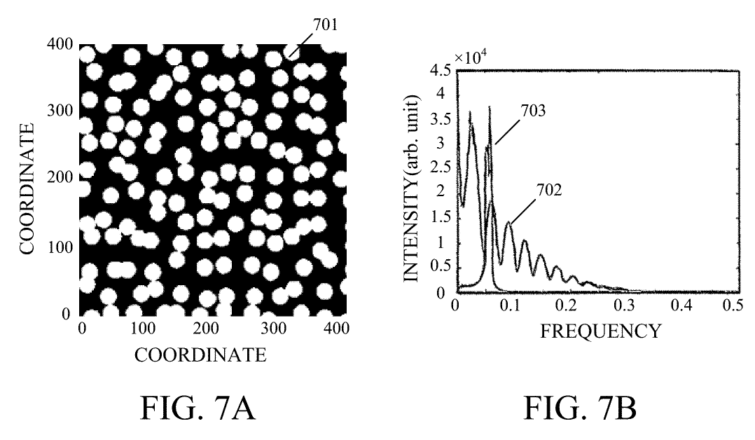

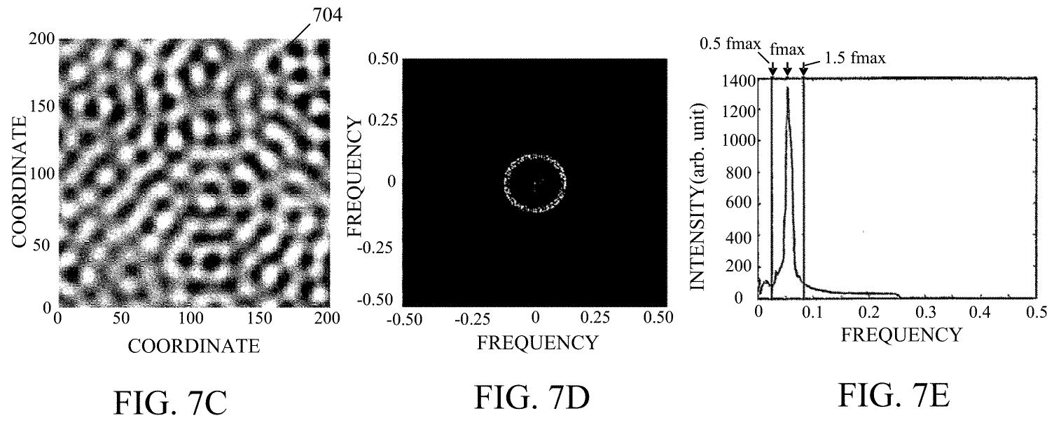

FIGS. 7A to 7F are explanatory views of a making method of the random uneven data according to this example. FIG. 7A illustrates random array data 701. The random array data 701 is data obtained by giving an arbitrary shift from −10 to 10 in the x direction and the y direction after arraying a circle having a diameter of 22 in a square array of 33 cycles. In this example, the random uneven data is made by performing the filter operation in the real space using a filtering function with respect to the random array data 701. In this example, the filtering function 102 explained in the first example, and the expressions (8) and (9) are satisfied. FIG. 7B illustrates a frequency spectrum 702 obtained by being made into one-dimensional in a radial direction of the random array data 701, and a frequency spectrum 703 obtained by being made into one-dimensional in a radial direction of the filtering function 102.

FIG. 7C illustrates random uneven data 704 made by performing the filter operation. FIG. 7D illustrates the two-dimensional frequency spectrum of the random uneven data 704, and FIG. 7E illustrates a frequency spectrum obtained by making the two-dimensional frequency spectrum of the random uneven data 704 into one-dimension in a radial direction. As illustrated in FIG. 7D, the random uneven data 704 has the desired frequency determined by the filtering function. According to FIG. 7E, the average frequency <f> is also calculated to be 0.06.

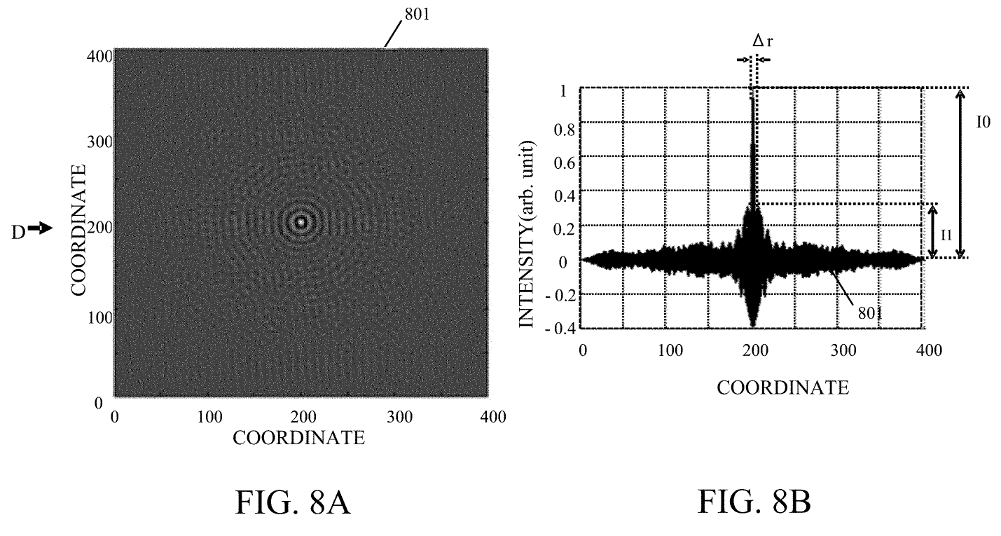

FIGS. 8A and 8B are explanatory views of a two-dimensional autocorrelation function 801 of the random uneven data 704. FIG. 8A is an overhead view of the autocorrelation function 801, and FIG. 8B illustrates the autocorrelation function 801 when projected from the direction shown as an arrow D of FIG. 8A. According to FIG. 8B, the distance Δr and the peak intensity ratio I1/I0 are respectively calculated to be 7 and 0.32. Then, the right member of the expression (10) is 0.91, and thus the random uneven data 704 satisfies the expression (10).

As mentioned above, the random uneven data 704 has the desired frequency components, and has the randomness without deviation in the two-dimension. In this example, the array length is set to be relatively small, the present invention is not this. Moreover, in this example, the random array data is obtained by arranging the circle on the basis of the predetermined random array regulation, but the present invention is not limited to this. The random array data may be obtained by arranging a predetermined shape part on the basis of a predetermined random array regulation.

### THIRD EXAMPLE

In this example, a description will be given of a method to make random uneven data by performing a filter operation in a real space using filtering function, which has bandpass performance continuously changing according to a position, with respect to random array data given by a random number. For example, a random uneven shape, which is used for a focus plate, preferably changes its characteristics according to a position. The focus plate, where a random uneven shape formed on the basis of the random uneven data made by the method according to this example is applied, can have characteristics which are different for each image height, and thus can improve performance. Table 3 shows one example of set values of parameters and values of conditional expressions regarding this example.

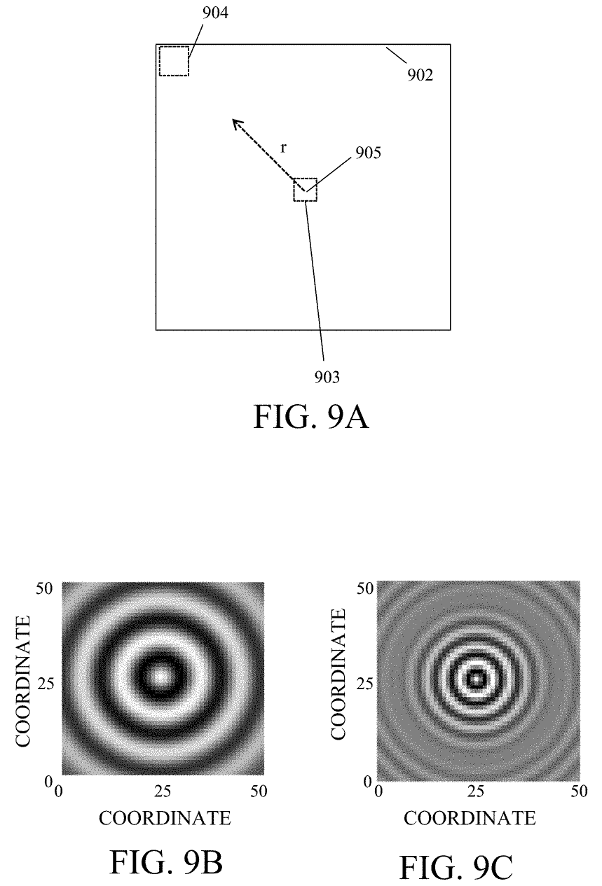

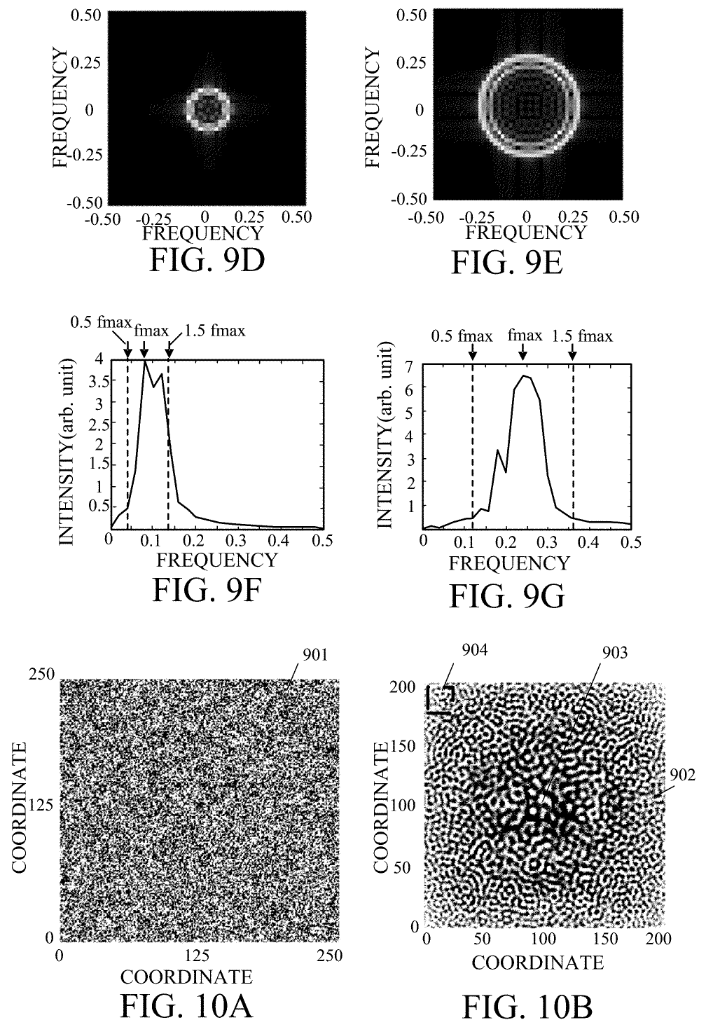

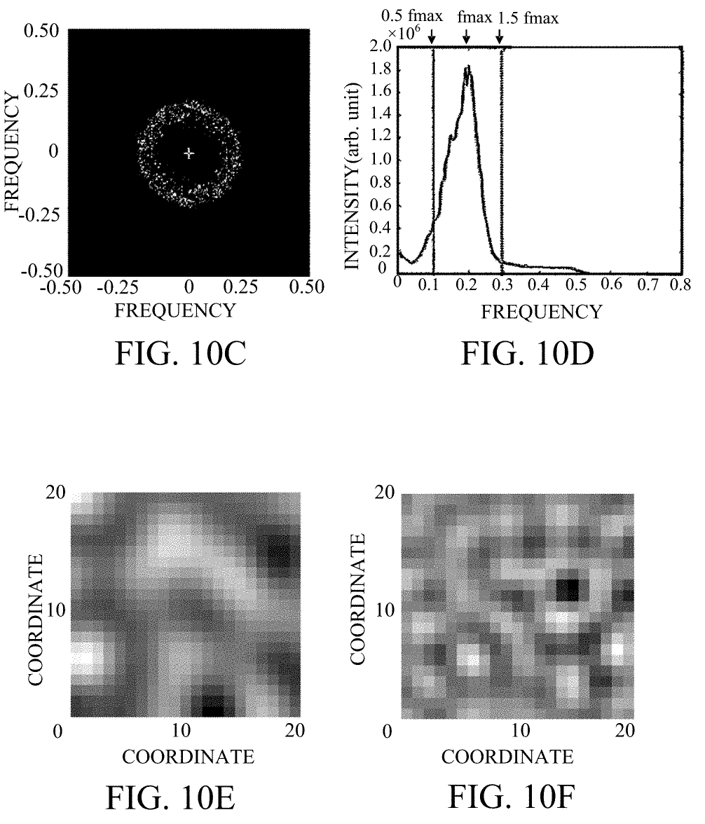

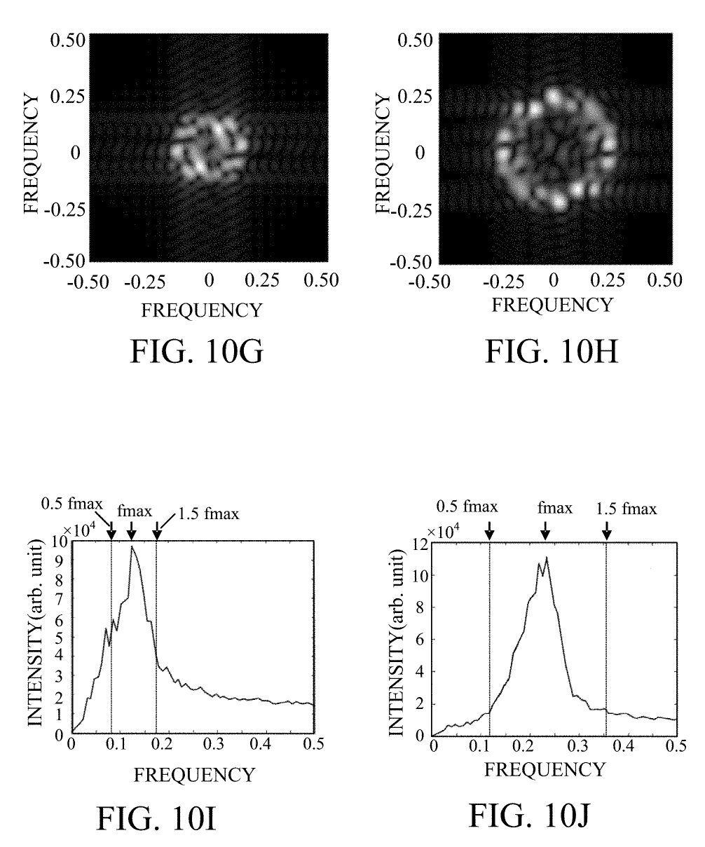

Referring to FIGS. 9A to 9G and FIGS. 10A to 10J, a description will be given of a filter operation when characteristics of a filtering function are changed according to a position. FIGS. 9A to 9G are explanatory of the filtering function according to this example. FIGS. 10A to 10J are explanatory views of the filter operation according to this example. Random array data 901 according to this example illustrated in FIG. 10A is made by a random number and has a uniform white frequency spectrum. Array lengths of the random array data 901 are 249×249. Performing the filter operation in the real space using the filtering function having the bandpass performance continuously changing according to a position with respect to the random array data 901 can random uneven data 902 illustrated in FIG. 10B. The random uneven data 902 has a central local area 903 and a peripheral local area 904.

In this example, a description will be given of the case of changing coefficients of the filtering function according to a distance r from a central position 905 as one example to change characteristics of the filtering function according to a position. The filtering function is represented by the expressions (2) to (6). In this example, setting the coefficients PH and PL to functions PH(r) and PL(r) of the distance r can characteristics of the filtering function according to a position. To continuously change characteristics of the filtering function from a center to a periphery, the functions PH(r) and PL(r) are represented by the following expressions (14) and (15) to be small dependent on the distance r.

PH(r)=9/(1+2r/((Nrx−Nfx+1)·(Nry−Nfy+1))^{0.5}) (14)

PL(r)=11/(1+2r/((Nrx−Nfx+1)·(Nry−Nfy+1))^{0.5}) (15)

FIGS. 9B and 9C respectively illustrate each shape of filtering functions corresponding to the central local area 903 and the peripheral local area 904. FIGS. 9D and 9E respectively illustrate a two-dimensional frequency spectrum of the filtering functions corresponding to the central local area 903 and the peripheral local area 904. FIGS. 9F and 9G respectively illustrate a frequency spectrum obtained by making the two-dimensional frequency spectrum of FIGS. 9D and 9E into one-dimension in a radial direction. According to FIGS. 9F and 9G, a minimum average frequency and a maximum average frequency according to this example are respectively calculated to be 0.13 and 0.24. Additionally, as both the array lengths Nfx and Nfy of the filtering function according to this example are 50, the minimum value and the maximum value of the midst member of the expression (8) are respectively 6.5 and 12.0, and thus the expression (8) is satisfied. In addition, according to FIGS. 9B and 9C, the maximum value and the minimum value of the shortest distance rmin are respectively calculated to be 0.5 and 2.5.

FIG. 10C illustrates a two-dimensional frequency spectrum of the random uneven data 902, and FIG. 10D illustrates a frequency spectrum obtained by making the two-dimensional frequency spectrum of the random uneven data 902 into one-dimension in a radial direction. As illustrated in FIG. 10C, the random uneven data 902 has the desired frequency determined by the filtering function. According to FIG. 10D, the average function <f> and the average pitch of the random uneven data 902 are respectively calculated to be 0.20 and 5.0. FIGS. 10E and 10F respectively illustrate a shape of the central local area 903 and the peripheral local area 904, which are cut at the array lengths of 20×20 corresponding to 4<P>×4<P> from the random uneven data 902. FIGS. 10G and 10H respectively illustrate a two-dimensional frequency spectrum of the central local area 903 and the peripheral local area 904. FIGS. 10I and 10J respectively illustrate a frequency spectrum obtained by making the two-dimensional frequency spectrum of FIGS. 10G and 10H into one-dimension in a radial direction. According to FIG. 10I, the average frequency <f1> of the central local area 903 is calculated to be 0.13, and according to FIG. 10J, the average frequency <f1> of the peripheral local area 904 is calculated to be 0.24. That is, the random uneven data 902 has characteristics where the frequency spectrum is different according to a position. Using the random uneven data capable of continuously changing the frequency spectrum according to a position for the surface shape of the light diffusion element can give diffraction characteristics suitable for each image height.

Besides, when characteristics of the filtering function are changed according to a position, a frequency spectrum at a local area preferably fully changes for each local area. Specifically, when an average pitch calculated from the frequency spectrum of the random uneven data is <P>, a local average pitch <P1> calculated from each frequency spectrum of a plurality of areas of the local area of 4<P>×4<P> is preferably 1.3 times or more different. When the local average pitch <P1> is at least 1.3 times or more different, the random data used for the light diffusion element can give diffusion characteristics suitable for each image height.

In this example, in FIG. 10I, the local average pitch <P1> of the central local area 903 is calculated to be 4.2 from the average frequency <f1>, and in FIG. 10J, the local average pitch <P1> of the peripheral local area 904 is calculated to be 7.7. As the ratio of the local average pitches is 1.83(=7.7/4.2), the local average pitch is 1.3 times or more different. Characteristics of the focusing plate is preferable to be optimized for each image height. As having the random uneven shape based on the random uneven data 902, the focusing plate has diffusion characteristics having a low angle at its center and a high angle at its periphery, and thus can improve take-in light quantity into the finder. Meanwhile, random uneven data having a ratio of the local average pitch smaller than 1.3 times have small change at the center and at the periphery of characteristics, and thus application of it to the random uneven data used for the focusing plate is undesirable.

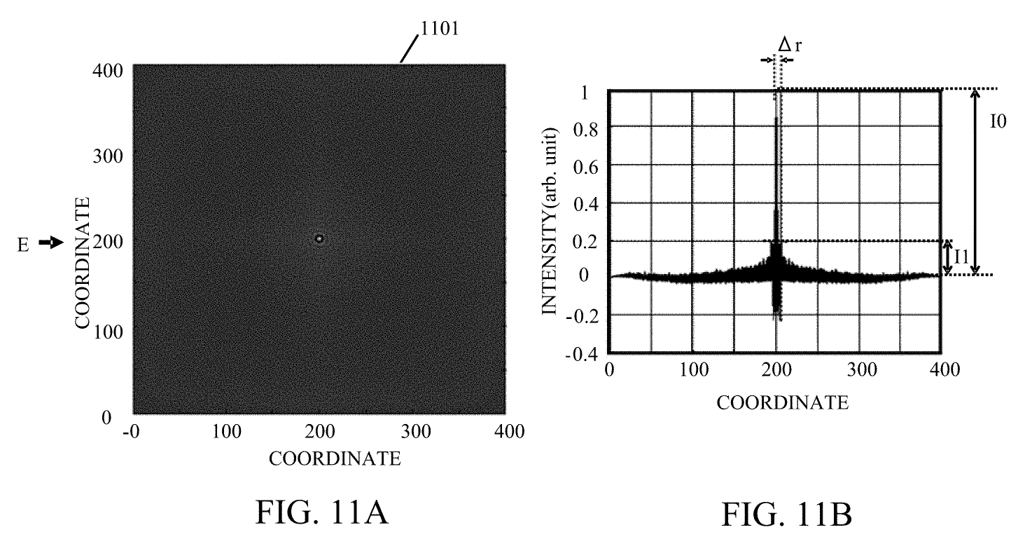

FIGS. 11A and 11B are explanatory views of a two-dimensional autocorrelation function 1101 of the random uneven data 902. FIG. 11A is an overhead view of the autocorrelation function 1101, and FIG. 11B illustrates the autocorrelation function 1101 when projected from the direction shown as an arrow E of FIG. 11A. According to FIG. 11B, the distance Δr and I1/I0 are respectively calculated to be 6 and 0.20. Then, the right member of the expression (10) is 0.93 and thus, the random uneven data 902 satisfies the expression (10).

As mentioned above, the random uneven data 902 has the desired frequency components, and has the randomness without deviation in the two-dimension. The random uneven data 902 also has the desired frequency components which are different in the central local area and the peripheral area. In this example, the array length is set to be relatively small, the present invention is not limited to this.

### FOURTH EXAMPLE

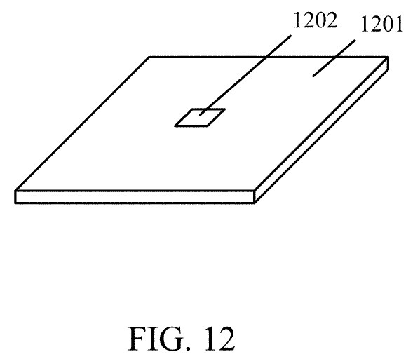

In this example, a description will be given of a light diffusion element 1201 which is one example of an optical element. The light diffusion 1201 has mainly light diffusion performance. FIG. 12 illustrates a shape of the light diffusion element 1201. On the whole surface of the light diffusion element 1201, a random uneven shape 1202 based on the random uneven data 105 according to the first example is formed.

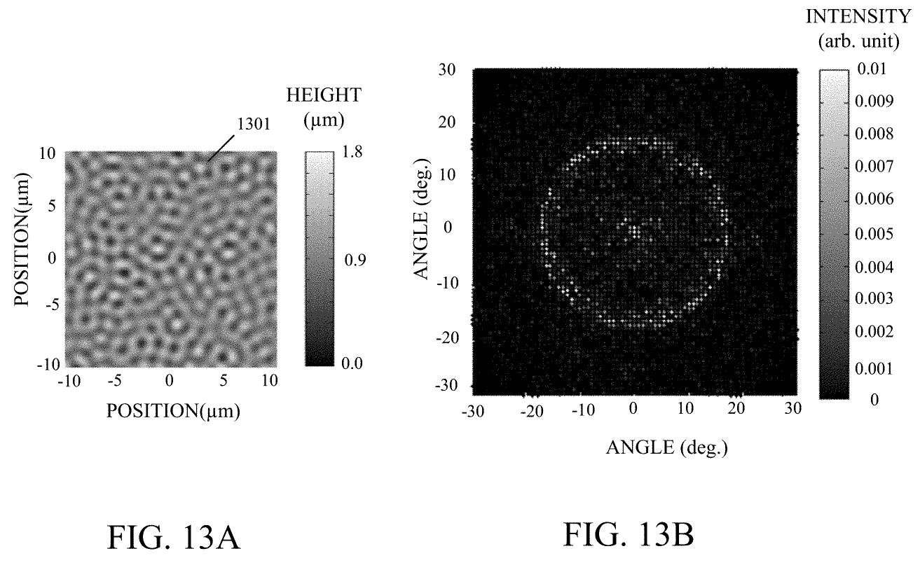

FIGS. 13A and 13B are explanatory views of a random uneven shape 1301 formed on the entire surface of the light diffusion element 1201. FIG. 13A is an overhead view of the random uneven shape 1301. In this example, as the grid size of the random uneven data 105 is 100 nm, the average pitch <Ps> of the random uneven shape 1301 is calculated to be 1.8 μm, and thus satisfies the expression (12). The average value of heights of the random uneven shape 1301 is also calculated to be 0.9 μm. The aspect ratio <hs>/<Ps> is 0.5, and thus satisfies the expression (13).

FIG. 13B illustrates remote field diffusion characteristics by the random uneven shape 1301. When a refractive index of a medium of the random uneven shape 1301 is 1.5 and a plane wave having a wavelength of 550 nm is made incident from the random uneven shape 1301 side, the remote field diffusion characteristics are obtained by a FDTD simulation. An abscissa axis and an ordinate axis of FIG. 13B represent a diffusion angle (degree). As illustrated in FIG. 13B, the random uneven shape 1301 has diffusion characteristics having intensity isotropically near 18 degrees. Such characteristics can realize diffusion without azimuthal anisotropy while focusing intensity in the desired angle direction.

Accordingly, as the average pitch <Ps> of the random uneven shape 1301 is 1.8 μm, the light diffusion element 1201 according to this example has diffusion characteristics to concentrate in a relatively high angle region, and thus is preferably used for a diffraction type lowpass filter. In this example, a size of the random uneven shape 1301 is set to be relatively small, the present invention is not limited to this. Moreover, approximately constant multiplication of the random uneven shape 1301 is preferably performed according to the desired diffusion angle distribution.

### FIFTH EXAMPLE

In this example, a description will be given of a light diffusion element 1201 which is one example of an optical element. The light diffusion 1201 has mainly light diffusion performance. FIG. 12 illustrates a shape of the light diffusion element 1201. On the entire surface of the light diffusion element 1201, a random uneven shape 1202 based on the random uneven data 105 according to the first example is formed.

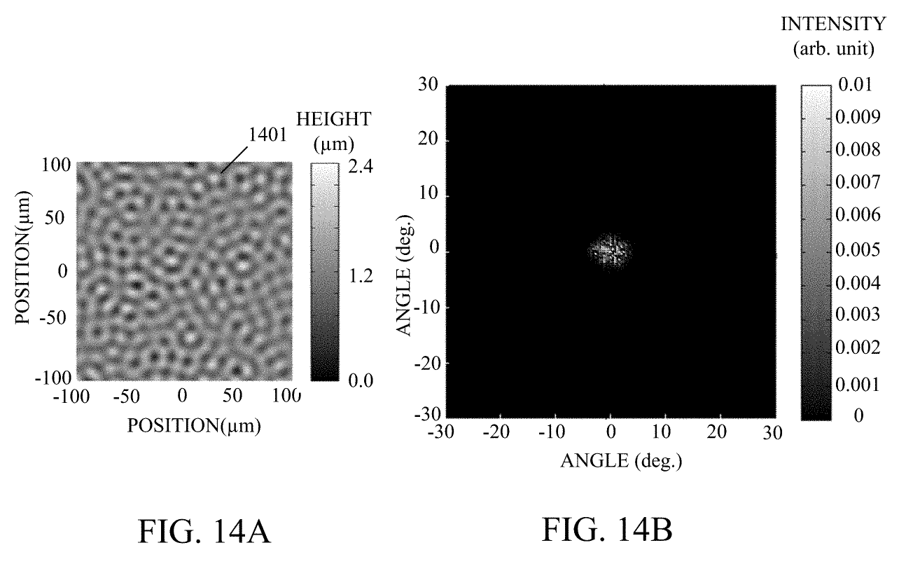

FIGS. 14A and 14B are explanatory views of random uneven shape 1401 formed on the entire surface of the light diffusion element 1201. FIG. 14A is an overhead view of the random uneven shape 1401. As the grid size of the random uneven data 105 is 1000 nm and the maximum value of the shape height is 2.4 μm, the average pitch <Ps> of the random uneven shape 1401 is calculated to be 18 μm, and thus satisfies the expression (12). The average value of heights of the random uneven shape 1401 is also calculated to be 1.2 μm. The aspect ratio <hs>/<Ps> is 0.7, and thus satisfies the expression (13).

FIG. 14B illustrates remote field diffusion characteristics by the random uneven shape 1401. When a refractive index of a medium of the random uneven shape 1401 is 1.5 and a plane wave having a wavelength of 550 nm is made incident from the random uneven shape 1401 side, the remote field diffusion characteristics are obtained by a FDTD simulation. An abscissa axis and an ordinate axis of FIG. 14B represent a diffusion angle (degree). As illustrated in FIG. 14B, the random uneven shape 1401 has diffusion characteristics having intensity isotropically in a low angle area. Such characteristics can realize diffusion without azimuthal anisotropy while focusing intensity in the desired angle direction.

Accordingly, as the average pitch <Ps> of the random uneven shape 1401 is 20.0 μm, the light diffusion element 1201 according to this example has diffusion characteristics to concentrate in a low angle region, and thus is preferably used for a diffraction type lowpass filter. In this example, a size of the random uneven shape 1401 is set to be relatively small, the present invention is not limited to this. Additionally, approximately constant multiplication of the random uneven shape 1401 is preferably performed according to the desired diffusion angle distribution.

### SIXTH EXAMPLE

In this example, a description will be given of a light diffusion element 1201 which is one example of an optical element. The light diffusion 1201 has mainly light diffusion performance. FIG. 12 illustrates a shape of the light diffusion element 1201. On the entire surface of the light diffusion element 1201, a random uneven shape 1202 based on the random uneven data 902 according to the third example is formed.

In this example, the grid size of the random uneven data 802 is 4000 nm and the maximum value of the shape height is 2.4 μm. In the random uneven shape according to this example, the average pitch <Ps> is calculated to be 20.0 μm and satisfies the expression (12). As the average height <hs> according to this example is also calculated to be 1.2 μm, the aspect ratio <hs>/<Ps> is 0.06, and thus satisfies the expression (13).

Characteristics of the focusing plate is preferable to be optimized for each image height. The focusing plate has diffusion characteristics having a low angle at its center and a high angle at its periphery, and thus can improve take-in light quantity into the finder. The local average pitches are different for each local area, and a random uneven shape 1301 formed on the entire surface of the light diffusion element 1201 has diffusion characteristics having a low angle at its center and a high angle at its periphery. Accordingly, as having the above characteristics and the random uneven shape including the average pitch <Ps> of 20.0 μm, the light diffusion element 1201 is preferably used for the focusing plate of the optical apparatus.

In this example, the size of the random uneven shape is set to be comparatively small, but the present invention is not limited to this. Furthermore, approximately constant multiplication of the random uneven shape is preferably performed according to the desired diffusion angle distribution.

### SEVENTH EXAMPLE

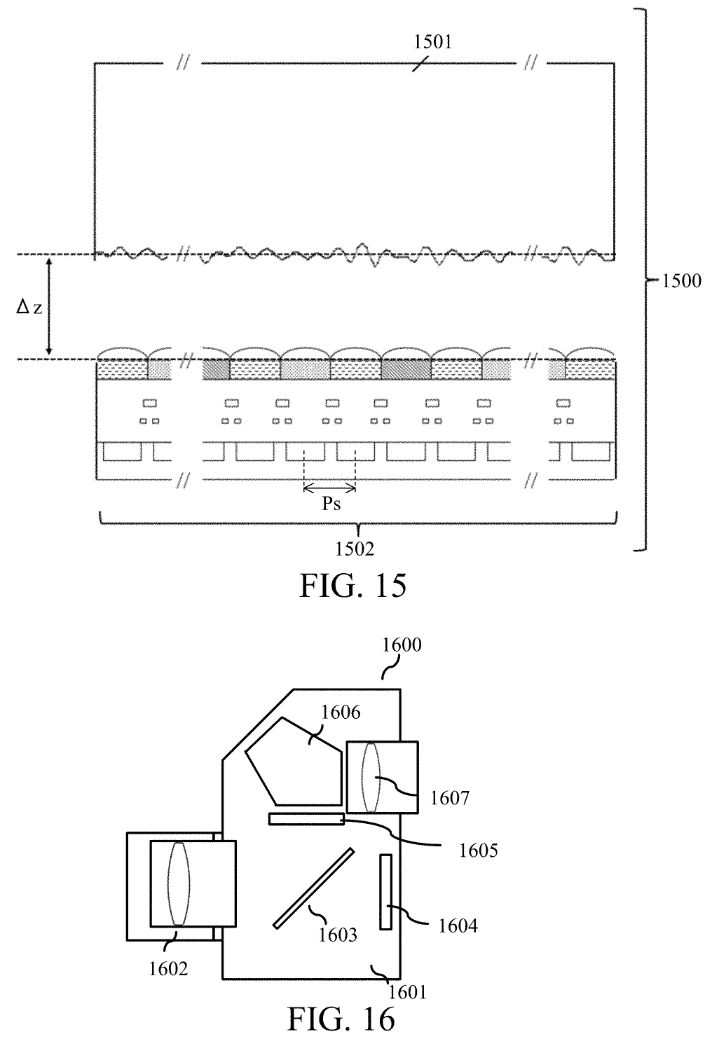

FIG. 15 is a schematic diagram of an image pickup apparatus 1500 which is one example of an optical apparatus. The image pickup apparatus 1500 includes a diffraction type optical lowpass filter 1501 and an image sensor 1502. The diffraction type optical lowpass filter 1501 is the light diffraction element according to the fourth example. The diffraction type lowpass filter 1501 is arranged at the position apart from the surface of the image sensor 1502 by a distance Az, and has performance to diffuse light incident to the image sensor 1502 at an appropriate angle. Diffuseness of the diffraction type optical lowpass filter 1501 becomes uniform regardless of an azimuth, and thus the image pickup apparatus 1500 can obtain MTF high in symmetry.

### EIGHTH EXAMPLE

FIG. 16 is a schematic diagram of an image pickup apparatus 1600 which is one example of an optical apparatus. The image pickup apparatus 1600 includes a camera body 1601, an image pickup lens 1602, a mirror 1603, an image sensor 1604, a focusing plate 1605, a pentaprism 1606, and an ocular lens 1607. The focusing plate 1605 is the light diffraction element according to the fifth or sixth example. The focusing plate 1605, the pentaprism 1606, and the ocular lens 1607 constitute a finder optical system. The focusing plate 1605 has performance to diffuse incident light at an appropriate angle and includes characteristics having small azimuthal anisotropy by randomness. Accordingly, the image pickup apparatus 1600 can suppress a two-wire blur and color unevenness. No deviation of the shape is generated and unnatural light falloff does not occur. The image pickup apparatus 1600 further improve take-in light quantity into the finder.

### FIRST COMPARATIVE EXAMPLE

In this comparative example, a description will be given of a making method of random uneven data by performing a filter operation in a real space using a filtering function, which fails to satisfy the expression (8), with respect to random array data given by a random number. Table 4 shows one example of set values of parameters and values of conditional expressions regarding this comparative example.

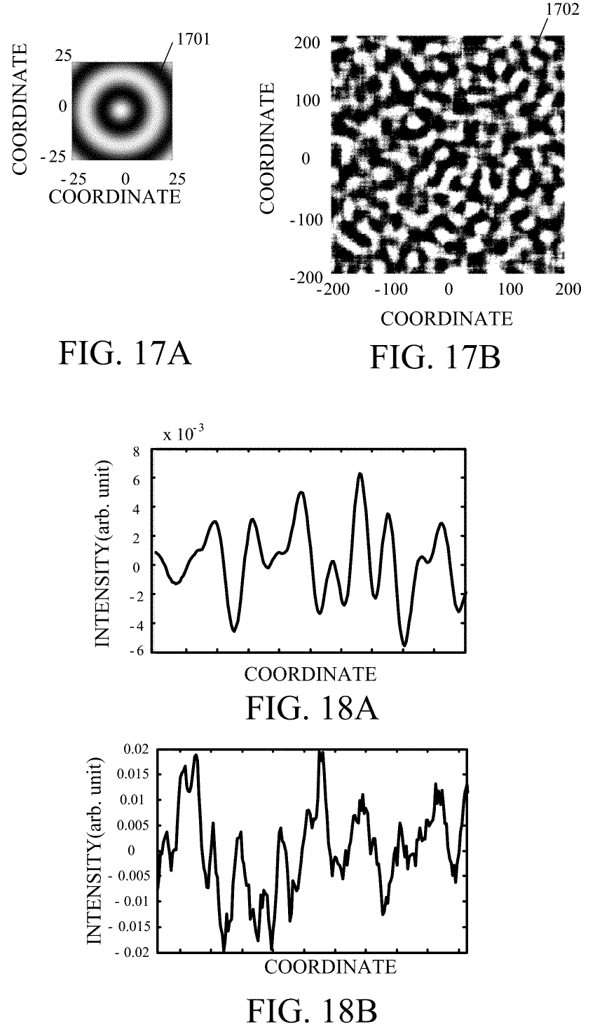

FIGS. 17A and 17b are explanatory views of the making method of the random uneven data according to this comparative example. FIG. 17A illustrates a shape of a filtering function 1701 used for the filter operation according to this comparative example. The filtering function 1701 is given by the expression (4) as with the first example, but the array lengths may be set to be 50×50. Accordingly, the middle member (Nfx·Nfy)0.5·<f> of the expression (8) is 3.0 and thus fails to satisfy the expression (8).

Random uneven data 1702 illustrated in FIG. 17B is obtained by performing the filter operation using the filtering function 1701 with respect to the central part of the array lengths of 249×249 of the random array data 101 according to the first example. FIGS. 18A and 18B respectively illustrate a sectional view of the random uneven data 105 made in the first example, and a sectional view of the random uneven data 1702 of FIG. 18B. As illustrated in FIG. 18B, in the random uneven data 1702, many high frequency vibration components due to the random number remains, and sufficient filtering is unperformed.

As mentioned above, when the filtering function fails to satisfy the expression (8), the desired frequency characteristics cannot be realized.

### SECOND COMPARATIVE EXAMPLE

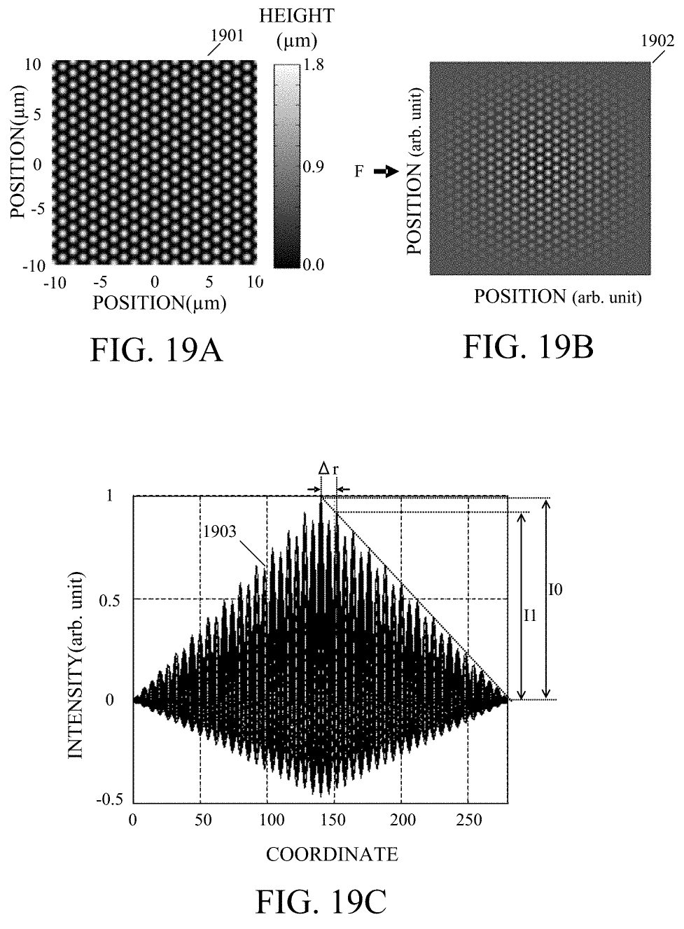

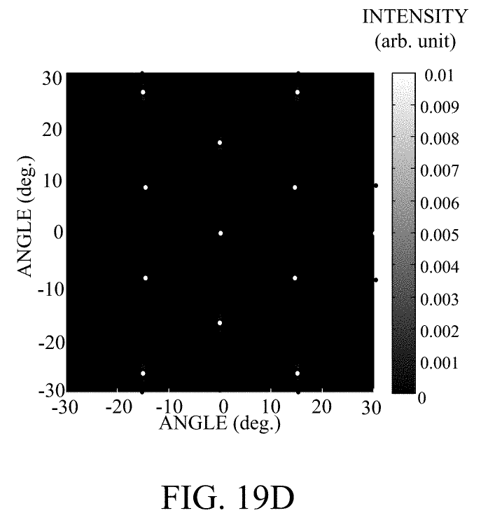

In this comparative example, a description will be given of a light diffusion element as an optical element using a regularly uneven shape formed on the basis of periodic data, which fails to satisfy the expression (8). The light diffusion element according to this comparative example mainly has performance to diffuse light. On a surface of the light diffusion element according to this comparative example, a regularly uneven shape 1901 illustrated in FIG. 19A, where a drill having a shape given one cycle of the following expression (16) is regularly arranged in six directions so that the average pitch Ps and the height are respectively 1.8 μm and 1800 nm, is formed.

U(r)=sin² r (16)

r represents a distance from the center. FIG. 19B is an overhead view of two-dimensional autocorrelation function 1902 of the regularly uneven shape 1901, and FIG. 19C illustrates the autocorrelation function 1902 when projected from projected from the direction shown as an arrow F. As illustrated in FIG. 19C, the autocorrelation function 1902 obeys an envelope 1903 with respect to a peak generated in the autocorrelation function 1902. In this comparative example, according to FIG. 19C, the distance Δr and a peak intensity ration are respectively calculated to be 12.0 and 0.92. Then, the right member of the expression (10) is 0.79, and thus the regularly uneven shape 1901 fails to satisfy the expression (10).

FIG. 19D illustrates remote field diffusion characteristics by the regularly uneven shape 1901. When a refractive index of a medium of the regularly uneven shape 1901 is 1.5 and a plane wave having a wavelength of 550 nm is made incident from the regularly uneven shape 1901 side, the remote field diffusion characteristics are obtained by a FDTD simulation. An abscissa axis and an ordinate axis of FIG. 19D represent a diffusion angle (degree). As illustrated in FIG. 19D, the regularly uneven shape 1901 has diffusion characteristics having large azimuthal anisotropy having an intensity peak at only an angle corresponding to each order. Such characteristics cause harmful effects such as a two-wire blur and color unevenness.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2016-152533, filed on Aug. 3, 2016, which is hereby incorporated by reference herein in its entirety.

TABLE 1
Embodiment 1

| Nrx, Nry | Nfx, Nfy | Nox, Noy | PH | PL | <f> |
|---|---|---|---|---|---|
| 399 | 200 | 200 | 8.5 | 9.5 | 0.06 |

| Conditional | Conditional | Conditional | Conditional |
|---|---|---|---|
| Expression | Expression | Expression | Expression (10) |
| (8) | (9) | (10) | Right member |
| (Nfx · Nfy)^{0.5} · <f> | rmin | I1/I0 | 1-2.5(Δr/(Nox · Noy)^{0.5}) |
| 11.2 | 3.0 | 0.27 | 0.93 |

TABLE 2
Embodiment 2

| Nrx, Nry | Nfx, Nfy | Nox, Noy | PH | PL | <f> |
|---|---|---|---|---|---|
| 399 | 200 | 200 | 8.5 | 9.5 | 0.06 |

| Conditional | Conditional | Conditional | Conditional |
|---|---|---|---|
| Expression | Expression | Expression | Expression (10) |
| (8) | (9) | (10) | Right member |
| (Nfx · Nfy)^{0.5} · <f> | rmin | I1/I0 | 1-2.5(Δr/(Nox · Noy)^{0.5}) |
| 11.2 | 3.0 | 0.32 | 0.91 |

TABLE 3
Embodiment 3

| | | | | | | Minimum | Maximum |
|---|---|---|---|---|---|---|---|
| Nrx, Nry | Nfx, Nfy | Nox, Noy | PH Area | PH Area | <f> | <f1> | <f1> |
| 249 | 50 | 200 | 1.6-4.5 | 1.9-5.5 | 0.20 | 0.13 | 0.24 |

| Conditional | Conditional | Conditional | Conditional |
|---|---|---|---|
| Expression (8) | Expression (8) | Expression (9) | Expression (9) |
| Minimum | Maximum | Minimum | Maximum |
| (Nfx · Nfy)^{0.5} · <f> | (Nfx · Nfy)^{0.5} · <f> | rmin | rmin |
| 6.5 | 12.0 | 0.5 | 2.5 |

| Conditional | Conditional |
|---|---|
| Expression (10) | Expression (10) Right Member |
| I1/I0 | 1-2.5(Δr/(Nox · Noy)^{0.5}) |
| 0.20 | 0.93 |

TABLE 4
Comparative example 1

| Nrx, Nry | Nfx, Nfy | Nox, Noy | PH | PL | <f> |
|---|---|---|---|---|---|
| 249 | 50 | 200 | 8.5 | 9.5 | 0.06 |

Conditional Expression (8)
(Nfx · Nfy)^{0.5} · <f>
3.0

What is claimed is:

1. A making method of random uneven data, the method comprising:
a step of making random uneven data by performing a filter operation in a real space using a filtering function with respect to random array data obtained using a random number or random array data obtained by randomly arranging a predetermined shape part.

2. The making method of the random uneven data according to claim 1, wherein the following conditional expression is satisfied:
4.0<(Nfx·Nfy)^{0.5}·<f><100
where <f> is a weighted average frequency calculated from a frequency spectrum of the filtering function, and Nfx and Nfy are respectively an array length in each direction of two directions, which are orthogonal to each other, of the filtering function.

3. The making method of the random uneven data according to claim 1, wherein the filtering function serves as a bandpass filter or a lowpass filter.

4. The making method of the random uneven data according to claim 3, wherein the following conditional expression is satisfied:
0.4<rmin<1000.0
where Cmax is a maximum value of absolute values of the filtering function, and rmin is the shortest distance from a coordinate corresponding to the maximum value Cmax to a coordinate corresponding to the absolute value Cmax/2.

5. The making method of the random uneven data according to claim 1, wherein the conditional expression is satisfied:
0.05<11/10<1−2.5·Δr/(Nox·Noy)^{0.5}
Nox=Nrx−Nfx
Noy=Nry−Nfy
where Nfx and Nfy are respectively an array length in each direction of two directions, which are orthogonal to each other, of the filtering function, Nrx and Nry are respectively an array length in each direction of two directions, which are orthogonal to each other, of the random array data, Nox and Noy are respectively an array length in each direction of two directions, which are orthogonal to each other, of the random uneven data, I0 and I1 are respectively intensity of a maximum peak and intensity of a second peak in an autocorrelation function of the random uneven data, and Δr is a distance from an origin of the autocorrelation function to a coordinate corresponding to the second peak.

6. The making method of the random uneven data according to claim 1,
wherein the random array data is divided into a plurality of pieces of unit random array data, and
wherein the filter operation is performed for each unit random array data.

7. The making method of the random uneven data according to claim 6, wherein the unit random array data includes a common area overlapping with an adjacent unit random array data.

8. The making method of the random uneven data according to claim 7, wherein a length in a first direction and a length in a second direction orthogonal to the first direction of the common area are respectively Nfx/2 and Nfy/2.

9. The making method of the random uneven data according to claim 1, a function shape of the filtering function changes according to a position.

10. The making method of the random uneven data according to claim 9, wherein when an average pitch calculated from a frequency spectrum of the random uneven data is <P>, a local average pitch <P1>, which is calculated from each frequency spectrum of a plurality of areas in a local area of 4<P>×4<P>, is 1.3 times or more different.

11. An optical element comprising:
a random uneven shape that is formed on the basis of random uneven data made by performing a filter operation in a real space using a filtering function with respect to random array data obtained using a random number or random array data obtained by randomly arranging a predetermined shape part.

12. The optical element according to claim 11, wherein the following conditional expression is satisfied:
0.8(μm)<<Ps><100(μm)
where <Ps> is an average pitch calculated from a frequency spectrum of the random uneven data.

13. The optical element according to claim 11, wherein the following conditional expression is satisfied:
0.01<<hs>/<Ps><2.0
where <hs> is an average height of the random uneven shape.

14. An optical apparatus comprising:
an optical element including a random uneven shape that is formed on the basis of random uneven data made by performing a filter operation in a real space using a filtering function with respect to random array data obtained using a random number or random array data obtained by randomly arranging a predetermined shape part.

15. The optical apparatus according to claim 14, wherein the optical element is a lowpass filter.

16. The optical apparatus according to claim 14, the optical element is a focusing plate in a finder optical system.
